(19) United States
(12) Patent Application Publication
(10) Pub. No.: US 2024/0425018 A1
(43) Pub. Date: Dec. 26, 2024

(54) VEHICLE TURNTABLE ASSEMBLY, AND PLATFORM AND SUPPORT STRUCTURE THEREOF

(71) Applicant: THE AUSTRALIAN TURNTABLE COMPANY PTY LTD, Kangaroo Flat, Victoria (AU)

(72) Inventors: Paul CHAPMAN, Kangaroo Flat (AU); Ben CHAPMAN, Kangaroo Flat (AU); Todd CHAPMAN, Kangaroo Flat (AU); Alex CHAPMAN, Kangaroo Flat (AU)

(73) Assignee: THE AUSTRALIAN TURNTABLE COMPANY PTY LTD, Kangaroo Flat, Victoria (AU)

(21) Appl. No.: 18/700,963

(22) PCT Filed: Oct. 13, 2022
(86) PCT No.: PCT/AU2022/051230

§ 371 Date: Apr. 12, 2024

(30) Foreign Application Priority Data
Oct. 14, 2021 (AU) 2021903302

(51) Int. Cl. B60S 13/02

(52) U.S. Cl. CPC B60S 13/02

(57) ABSTRACT

A ground-engaging support structure for rotating a vehicle-carrying platform supported thereby such that a vehicle driven onto the platform is rotatable about a rotational axis extending substantially perpendicularly to the ground, the structure including: a base for carrying and rotating the vehicle-carrying platform; and one or more ground-engaging mechanisms adjustably secured to and extending outwardly from the base for facilitating load distribution of the platform and vehicle thereon such that the support structure is operable on uneven or sloped ground.

### FIELD OF THE INVENTION

Disclosed herein is a vehicle turntable assembly configured for rotating vehicles. Also disclosed herein is a vehicle-receiving platform configured to be rotated by a vehicle turntable. There is also disclosed herein a ground-engaging support structure configured to rotate the disclosed platform.

### BACKGROUND

It is known to use vehicle turntables on certain construction sites to facilitate the movement of vehicles such as dump trucks and other large vehicles which can be difficult and time-consuming to manoeuvre (e.g., reverse or U-turn) in tight spaces.

Existing turntables are typically circular and sized such that their diameters must be sufficiently large to receive at least the front and rear wheels of the vehicle being rotated. As such, even if a vehicle is only long in one direction, the entire diameter of the turntable must be sized to be sufficiently large to accommodate the length of the vehicle. This results in turntables that have a relatively large footprint that can be more time and cost-intensive to transport, assemble, operate and disassemble.

Indeed, the time it takes to set up existing turntables on-site can be upwards of 10 hours, especially since the ground upon which the turntable is to operate must be relatively level, in which case additional concrete work may be required to underly the turntable. The labour, time and cost-intensive nature of such setups can severely limit the range of use cases in which a vehicle turntable would make fiscal sense.

Additionally, since installing and dismantling turntables can be so demanding, it often makes little sense to relocate them once installed, even if it would otherwise be desirable to. Relatedly, a turntable having a diameter suitable for vehicles of a certain size or operation at a particular location of a construction site may not be suitable for vehicles of other sizes or operation installation in other on-site locations. Given the above, the flexibility, adaptability and utilisation of turntables on construction sites can be rather limited.

Additionally, turntables powerful enough to rotate heavy loads often utilise rollers that add height to the turntable, resulting in a vehicle-receiving platform or surface that is raised relatively high off the ground. Separate track-like ramps are required to be positioned and secured to the raised platform to allow vehicles to drive up off the ground and onto the rotating platform. This added complexity calls for additional components and setup time and can limit the range of vehicles that can be driven onto the turntable. The need for relatively narrow track-like ramps also demands increased attention and skill from the vehicle operator, since misalignment of the vehicle's wheels and the respective ramps could be disastrous.

There is a need to address the above, and/or at least provide a useful alternative.

### SUMMARY

According to a first aspect of the present invention, there is provided a ground-engaging support structure for rotating a vehicle-carrying platform supported thereby such that a vehicle driven onto the platform is rotatable about a rotational axis extending substantially perpendicularly to the ground, the structure comprising:

a base for carrying and rotating the vehicle-carrying platform; and

one or more ground-engaging mechanisms adjustably secured to and extending outwardly from the base for facilitating load distribution of the platform and vehicle thereon such that the support structure is operable on uneven or sloped ground.

In embodiments of the invention, the structure comprises two or more stabilising legs, the first ends of which being generally equispaced from one another about the base.

In embodiments of the invention, the structure comprises two pairs of opposed stabilising legs.

In embodiments of the invention, the structure comprises a central ring that is rotatingly drivable about the rotational axis to rotate the platform.

In embodiments of the invention, the ring comprises a motorised slewing bearing that is selectively drivable in either direction about the rotational axis.

In embodiments of the invention, the base comprises one or more feet for adjustably engaging the ground.

According to a second aspect of the present invention, there is provided a vehicle-carrying platform for use as part of a vehicle turntable, the platform extending in a longitudinal direction and comprising opposed ends via which a vehicle can be driven onto and off the platform.

In embodiments of the invention, the opposed ends of the platform slope downwardly away from a centre of the platform such that the vehicle can drive onto and off the platform directly from and onto, respectively, the ground.

In embodiments of the invention, the platform comprises adjustable ground-engaging ramps extending outwardly from respective opposed ends via which the vehicle can drive onto and off the platform.

In embodiments of the invention, wherein the ground engaging mechanisms are adjustable supports extending from respective opposed ends to provide stability of the platform during which the vehicle can drive onto and off the platform.

In embodiments of the invention, the platform comprises fixed ground-engaging ramps extending outwardly from respective opposed ends via which the vehicle can drive onto and off the platform.

In embodiments of the invention, the platform comprises adjustable and/or removable wheels which may be motorised for driving and/or steering such that the turntable may be relocated under its own propulsion and/or via external propulsion

In embodiments of the invention, the platform comprises truss-like side walls between which the vehicle can be driven and parked for rotation.

According to a third aspect of the present invention, there is provided a vehicle turntable assembly comprising:

a ground-engaging support structure according to a first aspect of the present invention; and

a vehicle-carrying platform according to a second aspect of the present invention,

the platform being removably engageable with the support structure such that in use, the platform is rotatably driven by the support structure to effect rotation of a vehicle parked on the platform.

According to a fourth aspect of the present invention, there is provided a method of rotating a stationary vehicle using a vehicle turntable assembly according to a third aspect of the present invention, comprising:

arranging the support structure on the ground from which the vehicle is to be driven onto the platform;

placing the platform on the support structure;

driving the vehicle onto the platform; and

rotating the platform to rotate the vehicle to a desired extent.

In embodiments of the invention, the method further comprises, before driving the vehicle onto the platform, adjusting one or more feet of the ground engaging mechanisms and/or support structure such that the platform is generally level with the ground from which the vehicle is to be driven.

### BRIEF DESCRIPTION OF THE DRAWINGS

An embodiment of the invention will now be described, by way of example only, with reference to the accompanying drawings in which:

FIG. 1(a) is a top perspective view of a vehicle turntable assembly according to embodiments of the present invention;

FIG. 1(b) is a close perspective view of an end of an assembly according to another embodiment; and

FIG. 2(a) is a top perspective view of a ground-engaging support structure of the vehicle turntable assembly of FIG. 1(a)

### DETAILED DESCRIPTION

Embodiments of the present invention provide a low profile vehicle turntable assembly 2 onto which a heavy vehicle can be driven directly from the ground.

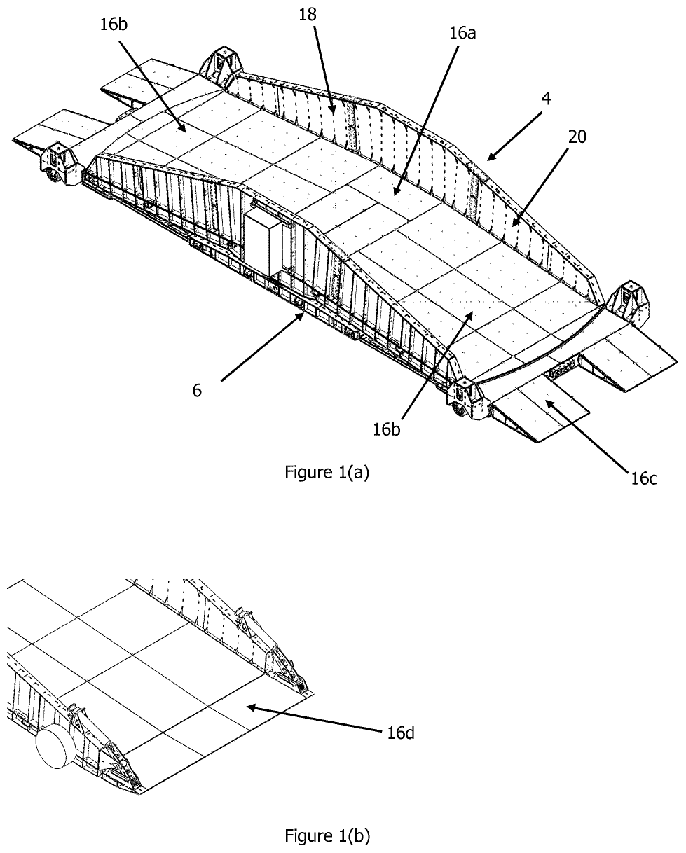

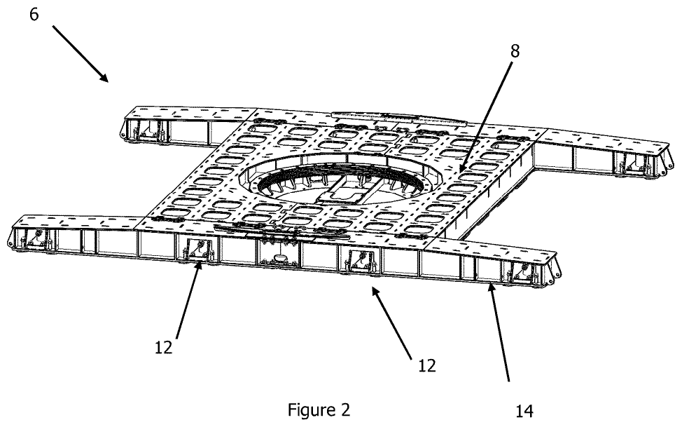

The turntable assembly comprises a longitudinally extending platform 4, shown in FIG. 1(a), configured to receive the vehicle to be rotated. The turntable assembly 2 also comprises a ground-engaging support structure 6 (FIG. 2) configured to support and rotate the platform 4.

Referring to FIG. 2, the ground-engaging support structure 6 comprises a base 8 configured to support and rotate the platform 4. In the depicted embodiment, the base 8 has a generally square profile and is fitted at its upper end with a motorised ring 10, not unlike a slewing bearing, which ring 10 is configured to removably engage a bottom of the platform 4 such that rotation of the ring 10 rotates the platform 4 and thus the vehicle parked thereon.

The base 8 is also fitted with two pairs of adjustable ground-engaging feet 12 or pads. The pads 12 may be reversibly screwed to and extend downwardly from a bottom of the base 8, whereby screwing of the pads 12 alters a height adjustment thereof. In this way, even if the ground on which the support structure 6 is to be set up is relatively uneven or sloped, the pads 12 can be adjusted up and down to help level the platform-receiving base 8.

Referring to FIGS. 1(a) and 1(b), the present patent specification also discloses a vehicle-carrying platform 4 that can be used with the presently disclosed ground-engaging support structure 6, though it will be appreciated that the platform 4 can be used and/or adapted for use with other and existing vehicle turntables.

In the Figures, the platform 4 has a bridge-like form and comprises a longitudinally extending bottom surface or floor 16 for receiving the tyres of the vehicle to be rotated.

the floor 16 of the platform comprises three main segments: a relatively flat central portion 16a, and opposed end portions 16b that slope downwardly away from the central portion 16a. The downwardly sloping end portions 16b of the platform floor 16 reduce the length and height of and ramps 16c.

In certain embodiments, the opposed ends of the platform 16b may be configured with adjustable, and possibly spring-loaded ramp 16d portions which can swing out from the opposed ends 16b, engage the ground and further facilitate the driving of vehicles onto and off of the platform 4.

The depicted platform 4 is relatively long and sized to rotate longer vehicles like semi-trailers. In driving such a heavy vehicle onto the platform 4, which platform 4 is substantially if not completely held off the ground by the ground-engaging support structure 6, it is important to ensure the platform 4 is not displaced relative to the support structure 6 (e.g., caused to bend or deflect in response to the vehicle slowly being driven onto the platform 4). To this end, the platform 4 comprises truss-like sidewalls 18 secured to and spanning the floor 16 of the platform 4, which sidewalls 18 help distribute loading from the vehicle as it is driven onto and off of the platform 4.

Existing turntables comprise circular platforms, the diameters of which are typically as large as the vehicle to be rotated. These circular platforms thus present unnecessary bulk (since most of the surface area of the platform is unused) and construction complexity, making them more difficult and costly to transport. In contrast, the present platform 4 need only be sized for the vehicle to be rotated, thereby significantly reducing the surface area occupied by the platform 4. Additionally, the construction of the depicted platform 4 allows for easier disassembly and transport, wherein the sidewalls 18 and the webs/bars 20 thereof can be readily dismounted from the floor 16 of the platform 4.

The present turntable assembly 2—with its low profile support structure 6, and a platform 4 that can be readily dismantled and stored—can be easily packed for shipping, assembled to suit a variety of ground and loading conditions, and disassembled, relocated and assembled yet again at another on-site location. It is envisaged that relocation of the present turntable assembly 2 can take as little as thirty minutes, which is orders of magnitude faster than existing industry turntables that can take over 10 hours to set up. The present turntable assembly 2 represents a drastic improvement in vehicle turntable technology and presents a far more versatile, adaptable, cost-effective vehicle turntable solution.

Many modifications of the above embodiments will be apparent to those skilled in the art without departing from the scope of the present invention. For example, the depicted platform 4 has a generally rectangular floor 16 suited for longer vehicles. Of course, platforms of different sizes and shapes can be adapted for use with the present ground-engaging support structure 6.

In other embodiments of the turntable assembly 2, it is envisaged that stabilising legs 14 may be extendible and/or retractable. The base 8 may also comprise arranged around the base 8. Indeed, the base 8 itself may have a different shape and structure, and could, for example, be rectangular or circular.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-16. (canceled)

17. A ground-engaging support structure for rotating a vehicle-carrying platform supported thereby such that a vehicle driven onto the platform is rotatable about a rotational axis extending substantially perpendicularly to the ground, the structure comprising:
a base for carrying and rotating the vehicle-carrying platform; and
one or more ground-engaging mechanisms adjustably secured to and extending outwardly from the base for facilitating load distribution of the platform and vehicle thereon such that the support structure is operable on uneven or sloped ground.

18. The structure of claim 17, comprising two or more stabilising legs, the first ends of which being generally equispaced from one another about the base.

19. The structure of claim 18, comprising two pairs of opposed stabilising legs.

20. The structure of claim 17, comprising a central ring that is rotatingly drivable about the rotational axis to rotate the platform.

21. The structure of claim 20, wherein the ring comprises a motorised slewing bearing that is selectively drivable in either direction about the rotational axis.

22. The structure of claim 17, wherein the base comprises one or more feet for adjustably engaging the ground.

23. A vehicle-carrying platform for use as part of a vehicle turntable, the platform extending in a longitudinal direction and comprising opposed ends via which a vehicle can be driven onto and off the platform.

24. The platform of claim 23, wherein the opposed ends of the platform slope downwardly away from a centre of the platform such that the vehicle can drive onto and off the platform directly from and onto, respectively, the ground.

25. The platform of claim 23, wherein the platform comprises adjustable ground-engaging ramps extending outwardly from respective opposed ends via which the vehicle can drive onto and off the platform.

26. The platform according to claim 23, wherein the ground engaging mechanisms are adjustable supports extending from respective opposed ends to provide stability of the platform during which the vehicle can drive onto and off the platform.

27. The platform according to claim 23, comprising fixed ground-engaging ramps extending outwardly from respective opposed ends via which the vehicle can drive onto and off the platform.

28. The platform according to claim 23, comprising adjustable and/or removable wheels which may be motorised for driving and/or steering such that the turntable may be relocated under its own propulsion and/or via external propulsion.

29. The platform of claim 23, comprising truss-like side walls between which the vehicle can be driven and parked for rotation.

30. A vehicle turntable assembly comprising:
a ground-engaging support structure including:
a base for carrying and rotating the vehicle-carrying platform; and
one or more ground-engaging mechanisms adjustably secured to and extending outwardly from the base for facilitating load distribution of the platform and vehicle thereon such that the support structure is operable on uneven or sloped ground; and
a vehicle-carrying platform extending in a longitudinal direction and comprising opposed ends via which a vehicle can be driven onto and off the platform,
the platform being removably engageable with the support structure such that in use, the platform is rotatably driven by the support structure to effect rotation of a vehicle parked on the platform.

31. A method of rotating a stationary vehicle using a vehicle turntable assembly according to claim 30, comprising:
arranging the support structure on the ground from which the vehicle is to be driven onto the platform;
placing the platform on the support structure;
driving the vehicle onto the platform; and
rotating the platform to rotate the vehicle to a desired extent.

32. The method of claim 31, further comprising, before driving the vehicle onto the platform, adjusting one or more ground-engaging mechanisms and/or support structure such that the platform is generally level with the ground from which the vehicle is to be driven.
